(19) United States
(12) Patent Application Publication
(10) Pub. No.: US 2020/0364951 A1
(43) Pub. Date: Nov. 19, 2020

(54) ENHANCED VEHICLE TRACKING SYSTEM

(71) Applicant: Vann Riley, Garden Ridge, TX (US)

(72) Inventor: Vann Riley, Garden Ridge, TX (US)

(21) Appl. No.: 16/413,495

(22) Filed: May 15, 2019

(51) Int. Cl. G07C 5/00; G08G 1/00

(52) U.S. Cl. CPC G07C 5/008; G08G 1/205

(57) ABSTRACT

An illustrated view of a system for providing enhanced vehicle tracking devices communications. The system provides an activation by alert systems on a vehicle in which it is installed, for example: school bus flashing lights or school zone flashing lights. For police and emergency vehicles, the system is useful for selection of severity of the event such as traffic stop, minor accidents, major accidents, active emergency—avoid area, etc. Further, the system is useful in communicating with existing vehicle alert systems, such as ON-STAR®, or navigation systems indicating the type of alert, severity of the alert, location of the alert and detours resulting from the alert.

### FIELD OF THE INVENTION

This invention relates to vehicle tracking systems. More particularly, it relates to optional alerts for a vehicle tracking system.

### BACKGROUND

A vehicle tracking system combines the use of automatic vehicle location in individual vehicles with software that collects these fleet data for a comprehensive picture of vehicle locations. Modern vehicle tracking systems commonly use GPS or GLONASS technology for locating the vehicle, but other types of automatic vehicle location technology can also be used. Vehicle information can be viewed on electronic maps via the Internet or specialized software. Urban public transit authorities are an increasingly common user of vehicle tracking systems, particularly in large cities.

Several types of vehicle tracking devices exist. Typically, they are classified as “passive” and “active”. “Passive” devices store GPS location, speed, heading and sometimes a trigger event such as key on/off, door open/closed. Once the vehicle returns to a predetermined point, the device is removed and the data downloaded to a computer for evaluation. Passive systems include auto download type that transfer data via wireless download. “Active” devices also collect the same information but usually transmit the data in near-real-time via cellular or satellite networks to a computer or data center for evaluation.

Many modern vehicle tracking devices combine both active and passive tracking abilities: when a cellular network is available and a tracking device is connected it transmits data to a server; when a network is not available the device stores data in internal memory and will transmit stored data to the server later when the network becomes available again.

Vehicle OBD tracking systems make use of OBD GPS trackers that plug into the onboard diagnostic (OBD) port of a light or medium duty vehicle. A cellular OBD GPS tracker directly communicates with the cell tower for sending the location and other vehicle performance data to the server over cellular wireless network. Usually, the tracker device draws power from the OBD port itself and contains a built-in antenna along with a GPS module for receiving the GPS signal. In addition, OBD trackers communicate with the different vehicle subsystems for receiving vehicle diagnostic and fuel consumption related data. Users can view the information using standalone software or web browser from a desktop/laptop computer or using smartphone apps.

Other systems commonly don't have access to local events which may not rise to emergency level but are necessary for current drivers to make intelligent decisions on where and when to detour or upcoming traffic or other events. Therefore, there is a need for an enhanced system to track and make known to drivers of events not only in the vehicle tracking devices but other localized less emergency type of situations.

### BRIEF DESCRIPTION OF THE DRAWINGS

FIG. 1 is an illustrated view of a system to provide enhanced vehicle tracking.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

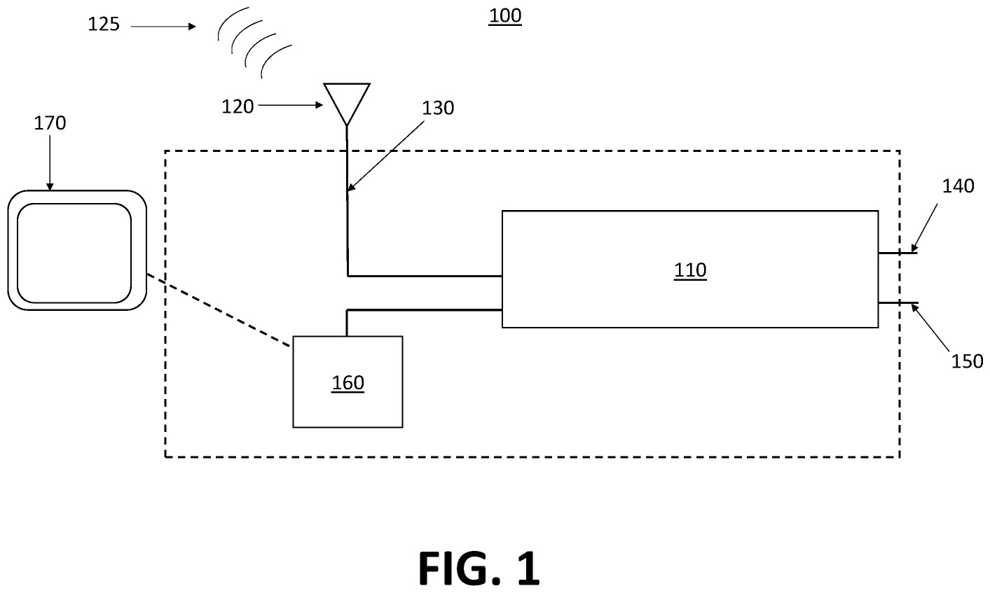

FIG. 1 is an illustrated view of a system 100 for providing enhanced vehicle tracking devices communications, also known as “Guardian Angel”. The system 100 provides an activation by alert systems on a vehicle in which it is installed, for example: school bus flashing lights or school zone flashing lights. For police and emergency vehicles, the system 100 is useful for selection of severity of the event such as traffic stop, minor accidents, major accidents, active emergency—avoid area, etc. Further, the system 100 is useful in communicating with existing vehicle alert systems, such as ON-STAR®, or navigation systems indicating the type of alert, severity of the alert, location of the alert and detours resulting from the alert.

The system 100 has a satellite/global positioning system (GPS) transponder 110. The transponder 110 receives signaling to and from alert carrying satellites and GPS satellites which have digital video data compression and multiplexing, several video audio channels travel through the transponder 110 on a single wideband carrier.

The transponder 110 is communicatively coupled to an antenna 120. The coupling of the transponder 110 and the antenna 120 is preferably by a cable 130, but other couplings are hereby contemplated including, but not limited to, wireless, coax, etc.

The antenna 120 receives signaling from and sends signaling to the satellites and/or GPS positions utilizing the proper signaling protocols 125. The antenna 120 receives signaling 125 from the satellites, such as ON-STAR®, government satellites, commercial satellites, etc., and communicates the signaling to the transponder 110.

The transponder 110 further is communicatively coupled to a power source 140 and a trigger 150. The power source 140 is preferably a 12-volt car battery, but other power sources are hereby contemplated including, but not limited to, solar, six (6) volt battery, etc.

The trigger 150 is coupled to the transporter 110 to alert the transporter 110 of an event experienced by the vehicle. The transponder 110 creates a message to send to a satellite, ON-STAR®, government agency, government satellite location, etc. The trigger 150 is preferably a toggle switch, but other types of trigger are hereby contemplated including, but not limited to, a button, wireless access via an app on a computing device, touch screen, etc.

The transponder 120 is communicatively coupled to a selector 160. The selector 150 is useful for selecting alerts or category of alerts to be received by the vehicle.

The selector 160 is communicatively coupled to a display 170. The display 170 receives alerts and/or categories related to the selection at the selector 160. The selections selected at the selector 160 may be selected from a menu on the display, via wireless connectivity, pre-selected at the selector 160 or another source.

When the transponder 110 receiving the signaling from the antenna 110, the transponder 110 outputs the signaling to the selector 160. The selector 160 determines channels to send to the display 170. The selection channels are based on the configured selections at the selector 160. The selector 160 maps the selections to the bands or frequencies of the signaling and then forwards those selected bands to the display 170 for display and alerting to the vehicle passengers.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for selecting alerts and initiating alert notifications, the system comprising:
a transponder, the transponder for receiving and initiating signaling information;
an antenna, the antenna for sending and receiving radio signaling, wherein the antenna being communicatively coupled to the transponder;
a power source, the power source coupled to the transponder, wherein the power source being for providing electrical power to the transponder;
a trigger, the trigger being coupled to the transponder for alerting the transponder of an event relating to the vehicle, wherein the trigger being one of: a toggle switch, a button, a wireless access via an app on a computing device and touch screen; and
the transponder sending a signal to a satellite containing the event information; and
a selector, the selector being communicatively coupled to the transponder for receiving signaling, wherein the selector being coupled to a display for sending a selected alert to the display for display.

2. The system of claim 1, wherein the system further comprising:
a trigger, the trigger being coupled to the transponder for alerting the transponder of an event relating to the vehicle; and
the transponder sending a signal to a satellite containing the event information.

3. The system of claim 2, wherein the satellite being ON-STAR®.

4. The system of claim 2, wherein the satellite being a governmental entity satellite.

5. The system of claim 2, wherein the trigger being a toggle switch.

6. The system of claim 1, wherein the power source being a 12-volt car battery.

7. The system of claim 1, wherein the antenna being coupled to the transponder by a cable.

8. The system of claim 1, wherein the selector being for selecting a category of alerts.

9. The system of claim 1, wherein the selector being for selecting additional alerts.

10. The system of claim 1, wherein the selector being for selecting from a menu.

11. The system of claim 1, wherein the signaling having digital video data compression.

12. The system of claim 1, wherein the signaling having more than one video audio channels.
